(19) United States
(12) Patent Application Publication
(10) Pub. No.: US 2025/0277624 A1
(43) Pub. Date: Sep. 4, 2025

(54) Method for drying plastic material, and system for carrying out the method

(71) Applicant: Motan Holding GmbH, Konstanz (DE)

(72) Inventors: Mario Gerlach, Leutkirch (DE); Moritz Marka, Leutkirch (DE)

(73) Assignee: Motan Holding GmbH, Konstanz (DE)

(21) Appl. No.: 19/065,021

(22) Filed: Feb. 27, 2025

(30) Foreign Application Priority Data
Mar. 1, 2024 (DE) 10 2024 000 723.7

(51) Int. Cl. F26B 21/12; F26B 9/06; F26B 21/00

(52) U.S. Cl. CPC F26B 21/12; F26B 9/063; F26B 21/001; F26B 2200/08

(57) ABSTRACT

In a method for drying plastic material in the form of granules, powder and the like, at least one drying air generator generates drying air which is conducted through plastic material situated in a drying bin. The drying air absorbs the moisture in the plastic material and exits from the drying bin as return air. An actual air quantity of the drying air supplied to the drying bin is detected by a flow measurement and regulated to a setpoint air quantity. An actual total air quantity of the drying air exiting from the drying air generator is regulated to a setpoint total air quantity. At least two drying bins are connected to the drying air generator by means of a drying air duct and a return air duct. In the drying air duct, there is an orifice plate flow meter, which is connected upstream of a motor-adjustable control valve.

### CROSS-REFERENCE TO RELATED APPLICATION

This application claims the benefit of German Patent Application DE 10 2024 000 723.7, filed on Mar. 1, 2024, the content of which is incorporated in its entirety.

### TECHNICAL FIELD

The disclosure relates to a method for drying plastic material and to a system for carrying out such a method.

### BACKGROUND

Prior to being processed in a processing machine, plastic material, such as plastic granules and the like, is dried in a drying bin to such an extent that the plastic material can be processed without problems. The drying air used for drying the plastic material is generated by means of a drying air generator and supplied to the drying bins. In general, the drying air flows though the plastic material situated in the drying bin from bottom to top, in the process absorbs any moisture contained in the plastic material and exits from the drying bin as return air via a return air duct. Frequently, several drying bins through which the return air is conducted are connected to one drying air generator. When the drying air generator is switched on, the maximum air quantity that it can generate is introduced into the system as the total air quantity. The total air quantity is distributed to the various drying bins based on a 100% air quantity design of the drying bin. The 100% air quantity design provides that each drying bin receives 100% of the air quantity based on its volume. A smaller drying bin thus receives less air than a larger drying bin, which requires a greater quantity of air. However, the quantity of drying air allocated to each individual drying bin is not optimal. As a rule, the individual drying bins receive more drying air than they actually need for the drying process. As a result, a considerable amount of energy is wasted. There is also the risk of the material overdrying.

### SUMMARY

The disclosure is based on the object of designing the method and the system used in the art in such a way that the drying bin only receives the amount of drying air that is needed for drying.

This object is solved by a method as disclosed and claimed, and by a system as disclosed and claimed.

In the method for drying plastic material, an actual air quantity of that drying air supplied to the drying bin is detected by means of the flow measurement. The actual air quantity is regulated to a setpoint air quantity intended for the respective drying situation. In addition, the actual total air quantity of the drying air exiting from the drying air generator is regulated to a setpoint total air quantity. This ensures that the drying air generator only generates as much drying air as is needed for drying the plastic material in the drying bin. Regulating the air quantity in the drying bin and the drying air generated in the drying air generator makes it possible to save energy. In particular, overdrying of the plastic material situated in the drying bin is reliably avoided.

The flow measurement is advantageously performed by means of an orifice plate flow meter in conjunction with a differential pressure-air characteristic curve. The air quantity to be supplied to the drying bin can be adapted optimally to the size of the drying bins and/or the plastic material to be dried and/or the throughput of the drying bin. The supplied air quantity is preferably adapted by the combined action of regulation, flow measurement and a control valve.

A differential pressure is advantageously measured at the orifice plate flow meter. For this, the pressure is detected upstream and downstream of the orifice plate flow meter and the differential pressure is determined in this way.

A differential pressure transducer is advantageously used to detect the differential pressure at the orifice plate flow meter. The orifice plate flow meter causes a back-pressure to be generated, which can be advantageously adjusted with regard to optimising the drying process. For this purpose, a control valve is advantageously provided, which can be adjusted according to requirements, preferably using an appropriate motor.

In order to determine the actual air quantity of the drying bin, with which optimal drying of the plastic material is possible with minimal energy expenditure, various parameters are used. Use is advantageously made for this purpose of the differential pressure at an orifice plate flow meter, the temperature of the drying air supplied to the drying bin, the static air pressure, a gas constant for the drying air and a formula saved for the geometry of the orifice plate flow meter. A controller can use these parameters to calculate the actual air quantity of the drying bin. This actual air quantity can be the volume flow or else the mass flow.

The static air pressure is measured at a position in a pipe of the drying bin or in the surrounding area. Optionally, the static air pressure can also be calculated by inputting the installation height of the drying bin.

The controller can be used to advantageously perform the regulation in such a way that the actual air quantity corresponds to the setpoint air quantity, with permissible tolerances advantageously being permitted.

Advantageously, the differential pressure at an orifice plate flow meter, a formula saved for the geometry of the orifice plate flow meter, the temperature of the drying air leaving the drying air generator, the static air pressure and a gas constant for the drying air are used to determine the actual total air quantity of the drying air generator. With regard to the formula, reference is made to DIN EN ISO 5167-2:2023-08. A controller uses these parameters to calculate the actual total air quantity of the drying generator. The orifice plate flow meter is located in the drying air duct of the drying air generator, via which drying air duct the drying air is supplied to the drying bin. The controller makes it easy to calculate the actual total air quantity. The controller is advantageously designed such that it regulates the actual total air quantity to a setpoint total air quantity, taking into account permissible tolerances. Regulation makes it possible to supply only that amount of drying air to the drying bin that is needed for the intended drying of the plastic material in this drying bin.

Reliable determination of the actual individual air quantity of the drying bin or of the actual total air quantity of the drying air generator is possible if the static air pressure is measured as one of the parameters in a pipe of the drying bin or the drying air generator, respectively, or also in the surrounding area.

A particularly simple adjustment of the actual total air quantity of the drying air generator is possible if the speed of a fan of the drying air generator is adjusted for this purpose. The drying air is generated with the fan, and the fan speed can be used to simply and accurately adjust the quantity of the drying air to be supplied to the drying bin.

As an alternative to adjusting the fan speed or also as an additional option, it is advantageously provided that in order to change the actual total air quantity of the drying air generator, at least one bypass line is provided, via which it is possible to conduct air from the pipe of the drying air generator. In this case, it is not necessary to change the speed of the fan. If there is too much drying air, the superfluous portion of this drying air can be discharged via the bypass line, so that the subsequent drying bin only receives the quantity of drying air required for the drying process.

If the drying air generator is used to supply two or more drying bins with drying air, then, advantageously, firstly the actual total air quantity of the drying generator is adjusted. Subsequently, the actual air quantity of the downstream drying bins is adjusted one after the other. This means that firstly the actual air quantity of the first drying bin that is switched on and downstream from the drying air generator is adjusted. As soon as this has been done, the actual air quantity of the next drying bin is adjusted. In this way, all of the drying bins that are switched on are adjusted one after the other.

In one particularly advantageous design, after they have been adjusted, the drying bins send the respective actual air quantities to a control unit of the drying air generator. The control unit calculates the actual total air quantity from the actual air quantities supplied to the individual drying bins. This actual total air quantity is compared with a setpoint total air quantity and, if necessary, adjusted until it corresponds to the setpoint total air quantity, taking a permissible tolerance into account.

In another advantageous approach to the method, it is possible that once again, firstly the actual total air quantity of the drying air generator is adjusted. Subsequently, an enable signal enables all of the switched-on drying bins to adjust the actual air quantities.

The system for carrying out the method is characterised in that a motor-adjustable control valve is connected upstream the orifice plate flow meter in the drying air duct of the drying bin. The control valve can be used to simply and accurately change the back-pressure of the drying bin such that the actual air quantity measured at the orifice plate flow meter corresponds to the setpoint air quantity.

The orifice plate flow meter is advantageously assigned a differential pressure transducer which is connected by signals to a control unit. The transducer is used to determine the pressure upstream and downstream of the orifice plate flow meter and calculate the differential pressure therefrom and supply it the control unit.

A motor of the control valve is preferably connected to the control unit. The control valve can thus very easily be adjusted to adjust the back-pressure of the drying bin.

In addition, a pressure gauge and a temperature sensor which detect the pressure and the temperature of the drying air in the drying air duct are advantageously connected to the control unit.

In one advantageous embodiment, the drying air generator in its drying air duct has an orifice plate flow meter which is connected downstream of a speed-adjustable fan.

The speed of the fan can advantageously be adjusted by a frequency converter, whereby the actual total air of the drying air generators can easily be adjusted.

The orifice plate flow meter of the drying air generator is advantageously assigned a differential pressure transducer which is connected to a control unit by signals.

The transducer can be used to detect the pressure upstream and downstream of the orifice plate flow meter and thus determine the differential pressure. The signal of the differential pressure transducer is supplied to the control unit so that the latter can take the differential pressure value into account in the calculations.

Advantageously, the signal unit of the drying air generator is connected to the signal unit of the drying bin by signals. If the system has more than one drying bin, then each of these multiple drying bins are advantageously provided with a signal unit, which are preferably connected to the signal unit of the drying air generator by signals. This enables a simple data exchange between the different control units.

In one advantageous embodiment, the drying air duct and the return air duct of the drying air generator are connected to one another by at least one bypass line. In said bypass line there is a motor-driven control valve, the motor of which is connected to the control unit of the drying air generator.

### BRIEF DESCRIPTION OF THE DRAWINGS

The invention is explained in more detail hereinbelow with reference to a plurality of embodiments illustrated in the drawings, which show:

FIG. 1: a schematic illustration of a drying bin of a system for drying plastic material.

FIG. 2: a schematic illustration of a system for drying plastic material with a drying air generator, downstream of which a plurality of drying bins is connected.

FIG. 3: a simplified illustration of a drying air generator of the system for drying plastic material.

FIG. 4: an illustration corresponding to FIG. 3 of a further embodiment of the drying air generator.

FIG. 5: an illustration corresponding to FIG. 3 of a further exemplary embodiment of a drying air generator of the system for drying plastic material.

FIG. 6: a schematic illustration of a further embodiment of a system for drying plastic material.

FIG. 7: a fan characteristic curve.

FIGS. 8 to 12: schematic illustrations of further embodiments of systems for drying plastic material.

### DETAILED DESCRIPTION

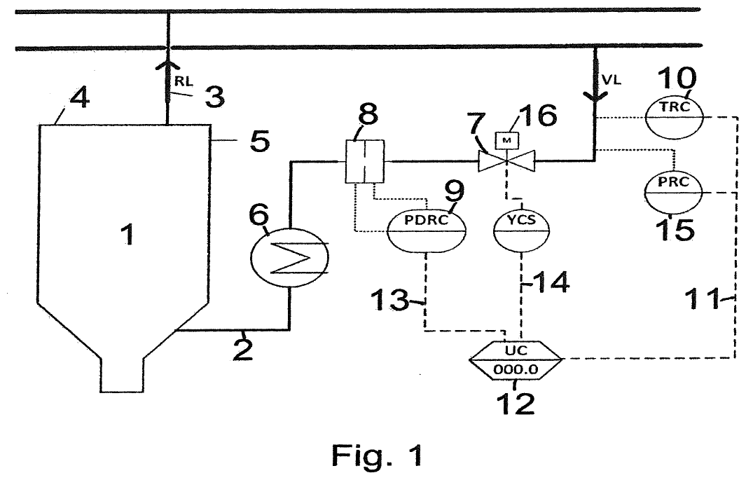

FIG. 1 shows a drying bin 1, in which the material to be dried, in particular plastic particles, such as granules, powder and the like, are situated. Drying air, which is supplied via a drying air duct 2, flows though said material from bottom to top. The drying air duct opens into the lower region of the drying air container 1.

As the drying air passes through the material, the drying air absorbs moisture which flows out of the drying bin 1 as return air via a return air duct 3. In the exemplary embodiment, the return air duct 3 is connected to the lid 4 of the drying bin 1. The return air duct 3 can also be connected to a side wall 5 of the drying bin 1 in the upper region of the drying bin 1.

Located in the drying air duct 2 is a heater 6, which can be used to heat the drying air to the temperature required for drying before it enters the drying bin 1, if this is necessary.

In the drying air duct 2 there is a control valve 7, which advantageously is operated electromechanically. The control valve 7 enables the back-pressure in the drying bin 1 to be increased or reduced. Arranged downstream of the control valve 7 is an orifice plate flow meter 8, which is connected to a differential pressure transducer 9. The latter measures the differential pressure over the orifice plate flow meter 8 in a known manner. The control valve 7 and the orifice plate flow meter 8 are arranged upstream of the heater 6 in the direction of flow of the drying air.

The air temperature in the drying air duct 2 is detected by means of a sensor 10 in the form of a temperature probe. The temperature signals of the sensor 10 are supplied via a control line 11 to a control unit 12, which is also supplied with the signals from the transducer 9 via a control line 13.

The transducer 9 detects the pressure upstream and downstream of the orifice plate flow meter 8.

In addition, the motor 16 of the control valve 7 is connected to the control unit 12 via a control line 14.

The drying air is circulated, with the drying air being heated to the required drying temperature using the heater 6 before it enters the drying bin 1, if necessary. To save energy, the heater 6 is therefore regulated such that the drying air entering the drying bin 1 is not too high, so that the dry material isn't damaged. The temperature probe 10 measures the temperature of the air that hits the orifice plate flow meter 8, in order to predict the air quantity as exactly as possible.

The fan used to generate the air flow is not illustrated in FIG. 1.

A pressure gauge 15 is used to detect the static air pressure in the drying air duct 2 in the direction of flow upstream of the control valve 7. The signals from the pressure gauge 15 are supplied to the control unit 12.

The static air pressure is measured at a position in the drying air duct 2 or in the surrounding area, optionally calculated by inputting the installation height of the drying bin 1.

The actual individual air quantity is calculated in the control unit 12, which quantity is supplied to the drying bin for drying the material situated therein. Used for this calculation are the differential pressure at the orifice plate flow meter 8 determined by means of the differential pressure transducer 9, a formula saved for the geometry of the orifice plate flow meter 9, the air temperature detected by the sensor 10 and the static air pressure determined by the pressure gauge 15. The actual individual air quantity can be the volume flow in m³/h or mass flow in kg/h.

The control unit 12 controls the motor 16 of the control valve 7 such that the back-pressure is changed such that the actual individual air quantity measured at the orifice plate flow meter 8 corresponds to the calculated setpoint individual air quantity, advantageously taking account of permissible tolerances. The setpoint individual air quantity is calculated via the material-specific air quantity m³ₐᵢᵣ/kgₘₐₜₑᵣᵢₐₗ and the current material throughput in kgₘₐₜₑᵣᵢₐₗ/h.

The control unit 12 is thus used to perform a regulation, which ensures that the actual individual air quantity always corresponds to the setpoint individual air quantity.

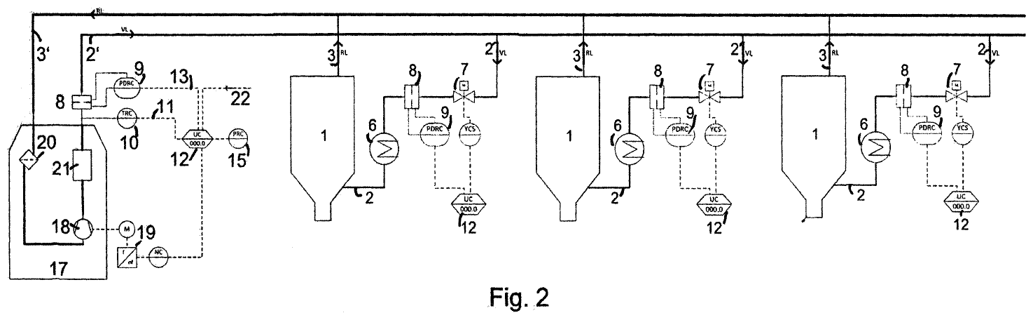

The procedure for drying bin 1 on its own has been explained with reference to FIG. 1. FIG. 2 now shows the case where the drying bin 1 is part of a multiple bin system.

In the exemplary embodiment illustrated, three drying bins 1 are provided, each of which are connected via a return air duct 3 to a shared return air duct 3′. Each of these drying bins 1 is connected in way described with reference to FIG. 1 connected to the control unit 12, by means of which the regulation of the individual air quantity of each drying bin 1 is adjusted. Expressed simply, the drying bin according to FIG. 1 is provided three times in the system according to FIG. 2.

The drying air ducts 2, which conduct the drying air into the respective drying bin 3 in the described manner, are connected to a shared drying air duct 2′.

The drying bins 1 are connected via the drying air duct 2′ and the return air duct 3′ to a drying air generator 17. The latter has a fan 18, which is driven by means of a drive 19.

The latter is connected to a control unit 12, which is used to operate the fan 18 to the required extent via the drive 19.

The return air conducted via the return air duct 3′ into the drying air generator 17 is guided through at least one filter 20 inside the drying air generator 17 and is thereby cleaned of dirt particles and the like.

Connected to the pressure side of the fan 18 is the drying air duct 2′ in which, inside the drying air generator 17, at least one desiccant cartridge 21 is arranged, with which moisture is adsorbed from the air.

Located in the drying air duct 2′, outside the drying air generator 17, there is an orifice plate flow meter 8, at which the differential pressure is detected in the manner described using the differential pressure transducer 9. The signals from the differential pressure transducer 9 are fed via the control line 13 to the control unit 12.

The air temperature in the drying air duct 2′ is detected by means of the sensor 10, which is connected via the control line 11 to the control unit 12.

Advantageously, in order to detect the air temperature, the sensor 10 is connected to the drying air duct 2′ in the region between the drying air generator 17 and the orifice plate flow meter 8. The temperature sensor 10 and the orifice plate flow meter 8 can also be positioned inside the drying air generator 17, however. The sensor 10 sends the temperature signals in the described manner via the control line 11 to the control unit 12.

The static air pressure is detected by means of the pressure gauge 15 which is connected to the control unit 12 in the manner described.

In the case of the system, the air temperature and the static air pressure are measured centrally in the drying air duct 2′ of the drying air generator 17.

The drying bins 1 each have the orifice plate flow meter 8 with the differential pressure transducer 9 and the motor-adjustable control valve 7 in the manner described.

Also located in the respective drying air duct 2 of the drying bin 1 is the heater 6, with which, if required, the temperature of the drying air can optionally be brought to the temperature for drying the material situated in the drying bin 1.

Unlike in the illustration according to FIG. 1, the air temperature and the static air pressure are no longer detected at the respective drying bin 1, but rather centrally in the drying air duct 2′.

Since the drying bins 1 are arranged at a distance from the drying air generator 17, the air temperature decreases because of heat losses as the distance from the drying air generator 17 increases. Owing to the heat losses, the control units 12 of the drying bin 1 take a defined temperature reduction into account, depending on how far away they are from the drying air generator 17.

Furthermore, FIG. 2 reveals that the control unit 12 of the drying air generator 17 is supplied with a signal 22 which characterises the setpoint total air quantity. The setpoint total air quantity is made up of the setpoint individual air quantity of the various drying bins 1.

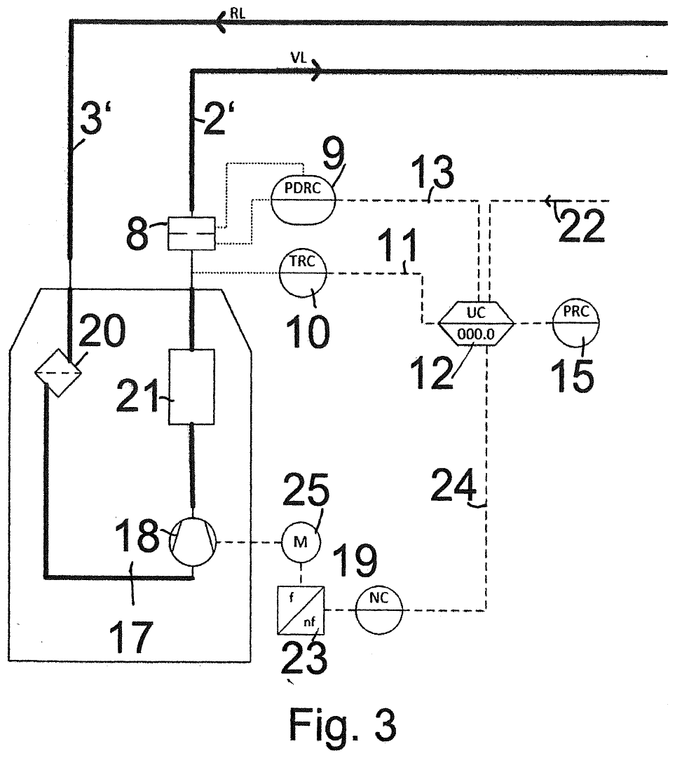

The mode of action of the drying air generator 17 is described with reference to FIG. 3. The control unit 12 calculates the actual total air quantity. This calculation takes into account the differential pressure detected by means of the differential pressure transducer 9 at the orifice plate flow meter 8, a saved formula that characterised the geometry of the orifice plate flow meter, the temperature of the drying air in the drying air duct 2′ determined with the sensor 10, the static air pressure determined using the pressure gauge 15 and a gas constant characteristic curve of the drying air. As explained with reference to FIG. 1, the actual total air quantity can be the volume flow or mass flow.

For the formula mentioned, reference is made to DIN EN ISO 5167-2:2023-08. It defines how the mass flow rate qₘ and, taking the air density into account, the volume flow qᵥ can be calculated.

The static air pressure is measured at a position in the drying air duct 2′ of the drying air generator 17 or in the surrounding area, optionally calculated by inputting the installation height.

The setpoint total air quantity, which is supplied as a signal 22 to the control unit 12, can be calculated from the sum of the individual air quantities detected at the individual drying bins 1. However, it is also possible to specify the setpoint total air quantity by inputting it at a control unit or the like.

The control unit 12 of the drying air generator 17 is used to adjust the total air quantity of the drying air in such a way that the actual total air quantity measured at the orifice plate flow meter 8 corresponds exactly to the input or calculated setpoint total air quantity, which is supplied as a signal 22 to the control unit 12.

The actual total air quantity can be regulated by the below-described three functions or devices in such a way that the actual total air quantity measured at the orifice plate flow meter 8 corresponds to the input or calculated setpoint total air quantity.

A first option for this is described with reference to FIG. 3. The drive 19 for the fan 18 has a frequency converter 23, which can be used to adjust the speed of the fan 18 and thus the actual total air quantity. The frequency converter 23 is connected to the control unit 12 of the drying air generator 17 via a line 24. The control unit 12 can be used to adjust the frequency converter 23 such that it drives a motor 25 of the fan 18 in such a way that the fan generates the required actual total air quantity.

Owing to the described control loop, the actual total air quantity that flows from the drying air generator 17 into the drying air duct 2′ is always maintained at the required value.

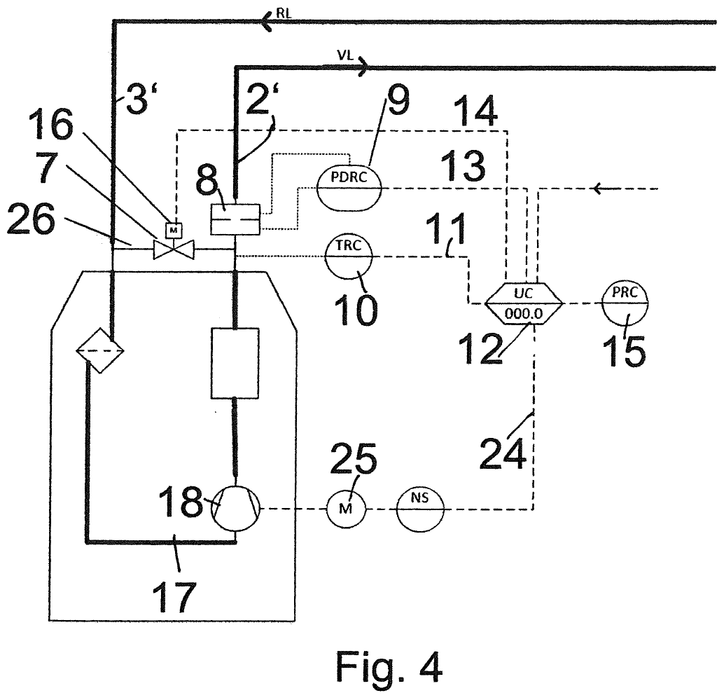

FIG. 4 shows a further way in which the actual total air quantity generated by the drying air generator 17 can be changed. Unlike in the embodiment according to FIG. 3, the fan 18 has a fixed speed. It is rotatably driven by the motor 25 which is connected to the control unit 12 of the drying air generator 17 via the line 24.

Located in the drying air duct 2′, outside or inside the drying air generator 17, is the orifice plate flow meter 8, at which the differential pressure can be detected using the differential pressure transducer 9. In addition, as the previous embodiment, the temperature of the drying air in the drying air duct 2′ is detected using the sensor 10 and a corresponding signal is sent to the control unit 12 via the line 1. The pressure gauge 15 is also connected to the control unit 12.

The drying air duct 2′ is connected to the return air duct 3′ via a bypass line 26. Located in the bypass line 26 is the control valve 7 which is actuated by means of the motor 16. The motor 16 is connected to the control unit 12 via the control line 14. Depending on the position of the control valve 7, a defined air quantity can be removed from the drying air duct 2′, whereby the actual total air quantity can be changed accordingly. The motor 16 for the control valve 7 is controlled via the control line 14 by the control unit 12.

As explained with reference to the previous exemplary embodiments, the control unit 12 uses the described values to calculate the actual total air quantity. Via the described control loop, the control unit 12 ensures that the actual total air quantity corresponds to the specified setpoint total air quantity.

If the control valve 7 is in its closed position, then no drying air is removed from the drying air supply line 2′ of the drying air generator 17. If the actual total air quantity is above the setpoint total air quantity, the control unit 12 controls the motor 16 via the control line 14 in such a way that the control valve 7 is adjusted to the extent that the actual total air quantity corresponds to the setpoint total air quantity again. Depending on the position of the control valve 7, a smaller or larger quantity of air is accordingly removed from the drying air duct 2′ and supplied to the return air duct 3′.

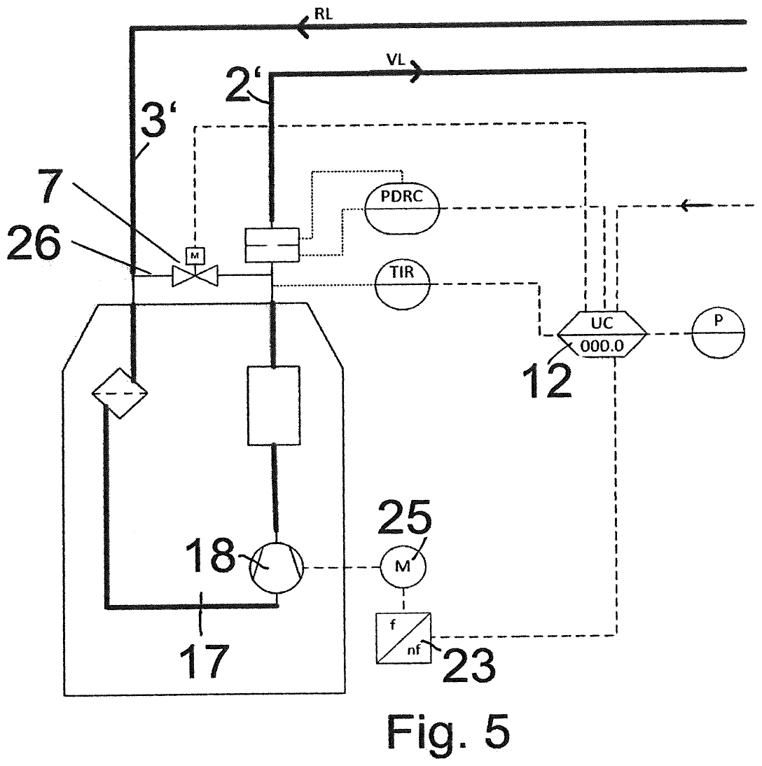

FIG. 5 shows a third way in which the actual total air quantity can be changed. The drying air generator 17 has the fan 18, the motor 25 of which is connected to the control unit 12 via the frequency converter 23, as described with reference to FIG. 3.

In addition, the bypass line 26 is provided with the control valve 7 between the drying air duct 2′ and the return air duct 3′.

The arrangement according to FIG. 5 is thus a combination of the arrangements according to FIGS. 3 and 4.

The frequency converter 23, controlled by the control unit 12, can be used to change the speed of the fan 18 so as to influence the actual total air quantity. It is additionally possible, also depending on the position of the control valve 7, to remove a defined quantity of air from the drying air duct 2′ and to transfer it to the return air duct 3′ via the bypass line 26 with the control valve 7.

These two measures in combination to change the actual total air quantity enable very low drying air quantities to be realised.

There are several possible ways of detecting the material throughput of the drying bin 1.

A first option consists in detecting the volume and converting it using the bulk density of the material to be dried to the mass throughput. The frequency of the conveying cycles and the device volume of the supplying conveyor, based on the device volume of the drying bin 1, is used for the mass throughput.

Instead of the supplying conveyor, the frequency of the conveying cycles and the device volumes of all of the extraction conveyors can be used.

A further option consists in providing a sensor for a maximum fill level and a sensor for a minimum fill level in the drying bin 1 and in observing the time taken for the bulk material level to fall in the drying bin 1.

The material throughput of the drying bin 1 can also be determined via the mass detection by weighing the drying bin 1.

A further way of detecting the material throughput of the drying bin 1 consists in evaluating information from other devices in the system. For example, information from weighed, supplying conveyors or from all weighed extracting conveyors can be used. Information from all extracting processing machines, such as injection moulding machines, can also be used and used to calculate the throughput.

These ways of detecting the material throughput of the drying bin 1 are known and will therefore not be described in detail.

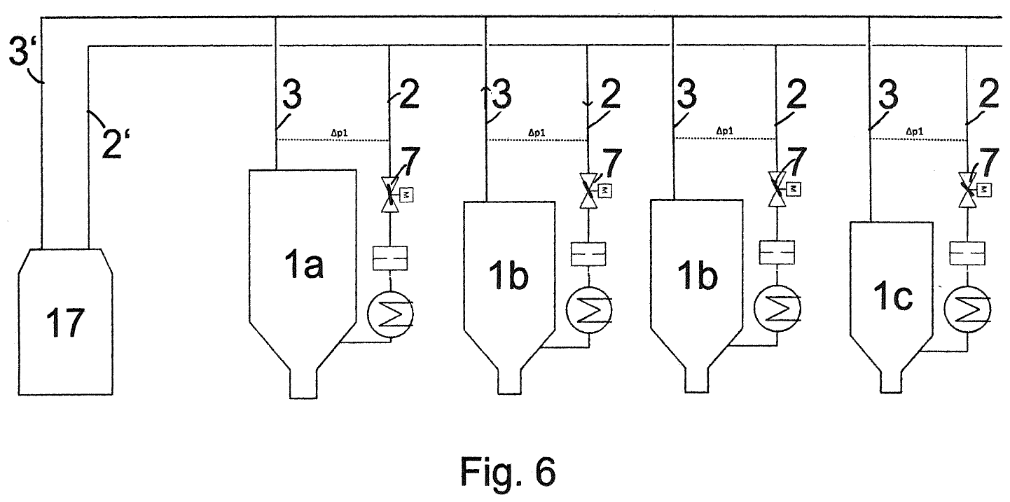

Reference is made to FIG. 6 to explain the design of the drying bin 1 within a system with a plurality of differently sized drying bins.

The system has the drying air generator 17, which is used to generate the drying air for drying the material situated in the drying bins 1a to 1c. The drying air is supplied from the drying air generator 17 via the shared drying air duct 2′, which is supplied via the drying air ducts 2 to the individual drying bins 1a to 1c. The drying air flows through the material in the drying bins 1a to 1c and exits the drying bins via the return air ducts 3. The return air laden with moisture is supplied via the shared return air duct 3′ to the drying air generator 17, in which the return air is filtered and processed in the described manner before it is supplied to the drying bins 1a to 1c again via the drying air ducts 2′, 2.

In the illustrated exemplary embodiment, the drying bin 1a has the greatest device volume. The two drying bins 1b have the same device volume, which is less than the device volume of the drying bin 1a, but greater than the device volume of the drying bin 1c.

Each drying bin 1a to 1c is assigned a control valve 7, which advantageously is electromechanically operated. When the system is switched off, the control valves 7 are adjusted such that the drying air ducts 2 are closed. The control valves assume a 0° position in this case.

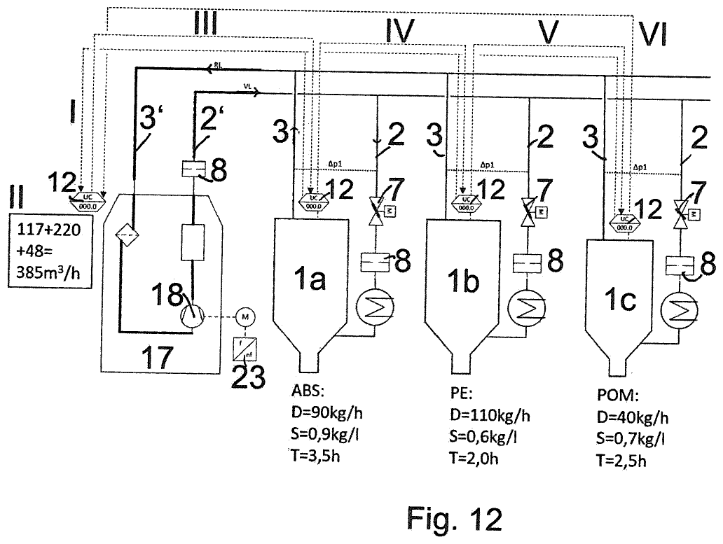

If the system is switched on, the control valves 7 are adjusted to a defined actuating angle between 0° and 90°. As a result, each drying bin 1a to 1c within the system firstly experiences the same basic pressure loss at the 100% air volume already described in the introduction. This will be explained in detail with reference to FIG. 12.

Owing to the appropriately adjusted control valve 7, there is a pressure difference Δp1 between the drying air duct 2 and the return air duct 3.

It is in principle also possible to open the control valve 7 fully when switching on the system, which corresponds to an actuating angle of 90°.

If, as in the exemplary embodiment, the drying bins 1a to 1c have different geometries depending on their size, the inherent pressure losses differ. In this case, different initial actuating angles are provided for the control valves 7 of the differently sized drying bins 1a to 1c. These different actuating angles are indicated in FIG. 6 by a thick line.

Then, the largest drying bin 1a has the largest actuating angle. In the case of the smaller drying bins 1ab, the actuating angle of the control valve 7 is smaller.

The defined actuating angles of the control valves 7 advantageously optimise the adjustment time of the respective drying bins 1a to 1c. When the system is switched off, the fan 18 (see e.g. FIG. 4) of the drying air generator 17 is switched off, meaning that its speed is zero. When the system is switched on, the associated control unit 12 (see e.g. FIG. 4) of the drying air generator 17 regulates the fan 18 from the speed of zero to the specified setpoint total air quantity or the setpoint speed of the fan 18. Depending on the design of the drying air generator 17, the control unit 12 adjusts the fan motor 25 (see e.g. FIG. 4) directly or via the frequency converter 23 (see e.g. FIG. 4).

Alternatively, the speed of the fan 18 (see e.g. FIG. 4) can also be calculated by means of a defined fan characteristic curve, a given pressure loss and a given setpoint total air quantity, resulting in an output speed for the fan 18 (see e.g. FIG. 4), which is adjusted is.

The output speed of the fan 18 calculated by means of the fan characteristic curve (see e.g. FIG. 4) is used to optimise the adjustment time of the drying air generator 17.

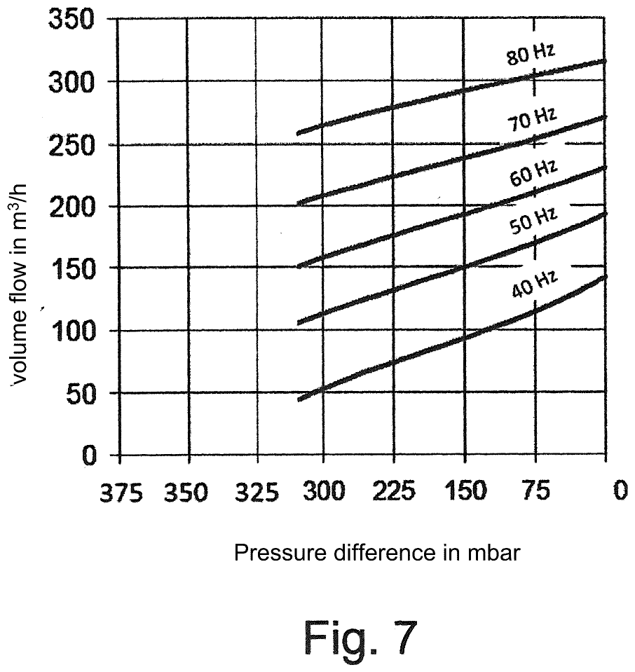

FIG. 7 shows an example of fan characteristic curves. The characteristic curves show that the intake volume flow, measured in m³/h, decreases with increasing total pressure difference. This applies irrespective of the frequencies at which the fan motor 25 (see e.g. FIG. 4) is operated.

If, by way of example, a total pressure loss of 75 mbar and also a setpoint total air quantity of approx. 120 m³/h ais assumed, then according to the characteristic diagram according to FIG. 7 a speed of the fan 18 of 40 Hz is set. The fan characteristic curve can thus be used to easily adjust the output speed of the fan 18.

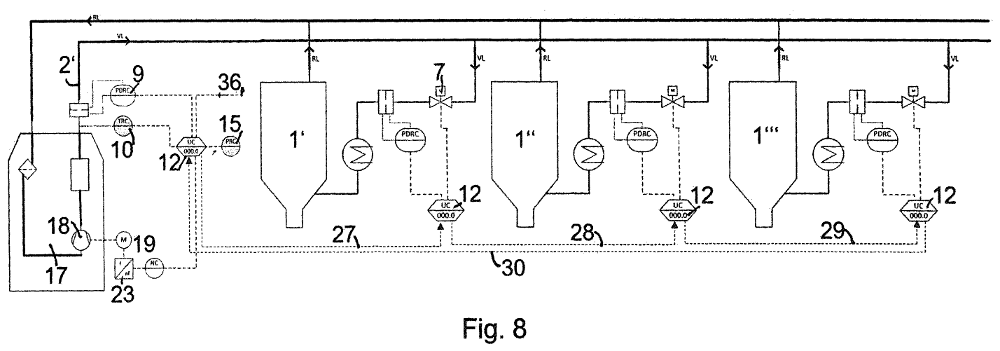

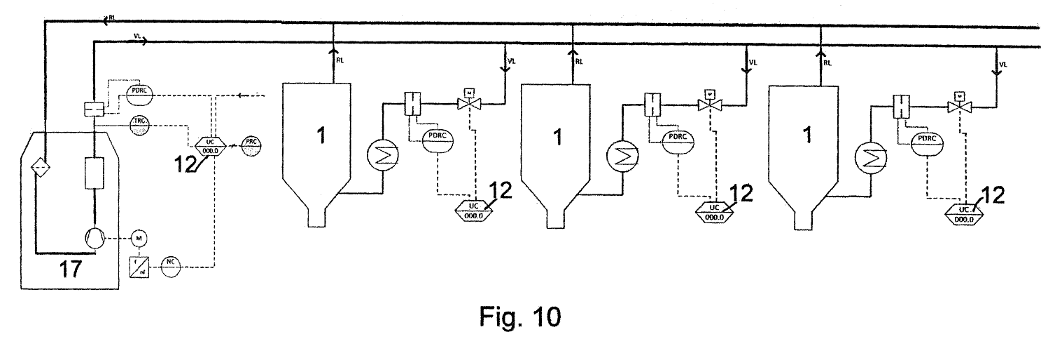

Three examples are described with reference to FIGS. 8 to 10 of how a method for adjusting the actual individual air quantity and the actual total air quantity within the system can be carried out.

A process-controlled adjustment of the system is explained with reference to FIG. 8. A prerequisite for such a process control is that at least one drying air generator 17 and one drying bin 1 are switched on. The system shown has, by way of example, a single drying air generator 10 and three drying bins 1, which are all the same size.

The drying bins 1 have a design that substantially corresponds to the embodiment according to FIG. 1. The only difference is that the sensor for static pressure measurement 15 and the sensor 10 for detecting the air temperature are assigned to the shared drying air duct 2′, as is the case in the exemplary embodiment according to FIG. 2.

The fan 18 of the drying air generator 17 is driven by the drive 19 having the frequency converter 23, as was described in detail with reference to FIG. 2.

The drying air generator 17 is the first device in the system to regulate the actual total air quantity.

As soon as the actual total air quantity corresponds to the setpoint total air quantity, permission is granted to adjust the actual individual air quantity for the for the first switched-on drying bin 1 in the system. It is assumed in the exemplary embodiment that the first switched-on drying bin 1 is the drying bin 1′ following the drying air generator 17. The adjustment of the actual individual air quantity to the setpoint individual air quantity is effected in this first drying bin 1′ using the control unit 12 in the manner described.

Once the adjustment of the drying bin 1′ is complete, permission is granted to adjust the subsequent switched-on drying bin 1″. The associated control unit 12 ensures that the actual individual air quantity of this drying bin 1″ corresponds to the setpoint individual air quantity.

Once the adjustment has been effected, permission is granted to adjust the next switched-on drying bin 1″, in which case the actual individual air quantity is again adjusted to the setpoint individual air quantity using the associated control unit 12 in the manner described.

This procedure is repeated for all of the other switched-on drying bins in the system.

The predefined actuating angle of the control valves 7 (FIG. 6) based on the 100% air quantity control allows the adjustment time of the respective drying bins 1 to be optimised.

The control units 12 are linked to one another such that the control units 12 in each case transmit corresponding switching signals. The control unit 12 of the drying air generator 17 sends the signal 27 to the control unit 12 of the first switched-on drying bin 1′. As soon as the adjustment is effected, this control unit 12 sends a signal 28 to the control unit 12 of the next switched-on drying bin. When the adjustment has ended, this control unit 12 for its part sends a control signal 29 to the control unit 12 of the subsequent switched-on drying bin.

Once all of the drying bins in the system have been adjusted, the control unit 12 of the last adjusted drying bin 1′″ sends a switch-on signal 30 to the control unit 12 of the drying air generator 17. With the help of this control unit 12, the actual total air quantity at the drying air generator 17 is checked again and adjusted, if necessary.

The control unit 12 of the drying air generator 17 receives the setpoint individual air quantities of the drying bins 1′ to 1′″ from the control units 12 thereof via the signal line 36. There is also the option to manually input the sum of the setpoint total air quantity of all drying bins 1′ to 1″″.

The described procedure of the system is carried out until all of the actual individual air quantities and the actual total air quantity, taking account of a permissible tolerance, correspond to the setpoint individual air quantities and the setpoint total air quantity.

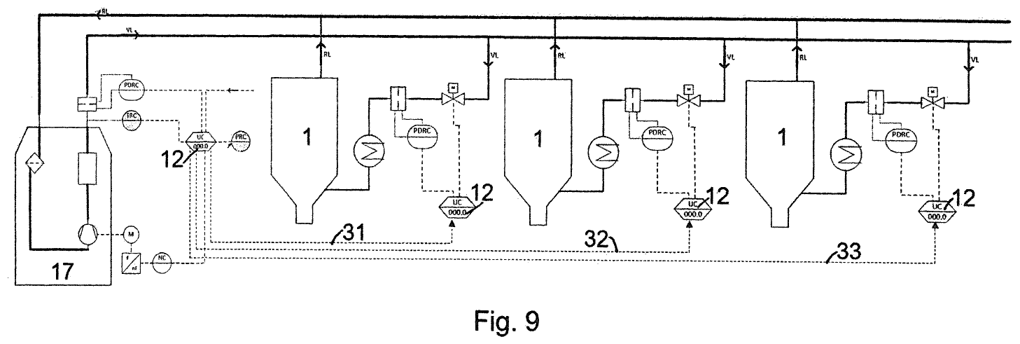

Another option for adjusting the drying air generator 17 and the drying bin 1 is explained with reference to FIG. 9. In this procedure, an alternating adjustment is effected. A prerequisite for this is, as in the method according to FIG. 8, that the drying air generator 17 and the drying bin 1 are switched on. The drying air generator 17 and the drying bin 1 are adjusted in the same way as was explained with reference to FIG. 8.

All switched on drying bins 1 regulate time interval the actual individual air quantity in a specified time interval as soon as it is outside of a permissible tolerance with respect to the respective setpoint individual air quantity. After a defined time has elapsed, the adjustment of the individual drying bin 1 is disabled. The control unit 12 of the drying air generator 17 then checks whether the actual total air quantity still corresponds to the setpoint total air quantity. If this is not the case, then a readjustment is made such that the actual total air quantity corresponds to the setpoint total air quantity within a permissible tolerance.

The actual individual air quantities of the drying bins 1 are then checked again at certain time intervals and if necessary readjusted with the associated control units 12. Then the total air quantity of the drying air generator is checked and regulated again.

The control unit 12 of the drying air generator 17 controls, in contrast to the previous embodiment, the individual control units 12 of the downstream drying bins 1. The corresponding switching signals 31 to 33 are indicated. The control unit 12 of the drying air generator 17 can activate the control units 12 of the drying bins 1 either in temporal succession or else at the same time.

With reference to FIG. 1, a procedure is described in which the switched-on drying bins 1 are freely adjusted. In contrast to the two previous embodiments, the control units 12 of the drying air generator 17 and the drying bin 1 are not directly connected to each other by signals.

So that the free adjustment can take place, at least the drying air generator 17 and the drying bin must be switched on.

The control unit 12 of the drying air generator 17 regulates the actual total air quantity in certain time intervals as soon as it is outside a permissible tolerance with respect to the setpoint total air quantity.

The control units 12 of the switched-on drying bins 1 also regulate the actual individual air quantities in certain time intervals as soon as these are outside a permissible tolerance with respect to the setpoint individual air quantities. The time intervals for the regulation among the drying bins 1 is selected so that only one of the switched-on drying bins 1 is regulated at a time.

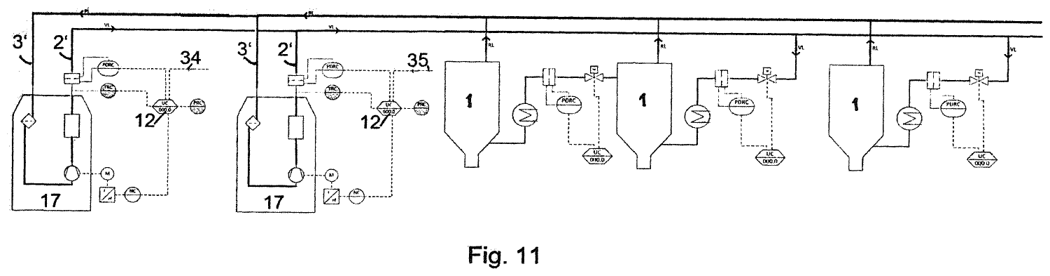

The various possible methods for the regulation explained with refence to FIGS. 8 to 10 are possible only in a system that contains just one or also a plurality of drying air generators 17. An example of such a system is shown in FIG. 11. In this system, two drying air generators 17 are provided which have the same design and are connected to the return air duct 3′ and to the drying air duct 2′ in the manner described. As in the previous exemplary embodiments, the control units 12 are provided to regulate the respective air quantity. In accordance with the exemplary embodiments according to FIGS. 8 to 10, the control units 12 of the two drying air generator 17 each receive signals 34, 35 that characterise the setpoint total air quantity of the switched-on drying bins 1. The setpoint total air quantity is either input manually or the sum of the individual air quantities of each individual drying bin 1 is transferred.

The drying bins 1 are advantageously have the same design, advantageously corresponding to the previous described embodiments.

With the described methods, the total air quantity is optimally distributed to the drying bins 1 in the system according to demand. It is carried out depending on the type of material situated in the respective drying bin 1 and on the throughput of the respective drying bin. The individual air quantity calculated theoretically via the specific air quantity is thus not only used for the initial design but is also adjusted at the respective drying bins 1 in the manner described by means of the control units 12. The drying air generator 17 for its part is designed such that it only delivers the quantity of air that is actually needed in the system for the individual drying bins 1.

The described method is characterised in that an optimum amount of heat is introduced into the drying bin 1 by the described air quantity distribution to each individual drying bin 1. Optimum drying results are achieved thereby. The material situated in the drying bins 1 is dried such that the required target residual moisture in the material to be dried is reliably achieved within an optimum time. The material is protected by the optimum heat input. In particular, overdrying is avoided.

With the described methods, a high level of energy savings can also be achieved because the heating performance can be optimally adjusted for the drying air.

The drying air generator 17 also operates in an energy-saving manner because the speed of its fan 18 is precisely matched to the required total air quantity.

Since the temperature of the drying air is detected by means of the sensors 10 at the individual drying bins 1, there is no increase or only a slight increase in the return air temperature when the system is in operation. This means that no re-coolers are needed in the system, meaning that the initial costs for the system can be minimised.

If the material in the drying bins 1 is changed and the material-characterising parameters are respectively input into the control unit 12, the optimum air quantity for the respective drying bin 1 is automatically determined and adjusted in the manner described. It is particularly advantageous when the system adjusts itself, i.e. the drying air generator 17 only provides the total air quantity required for drying the material in the drying bins and the drying bins 1 are adjusted for an individual drying air quantity.

The basic pressure setting of the individual drying bins 1 is performed via the control valves 7. They are adjusted, depending on drying bin size and material contents, to different angle positions, as explained by way of example with reference to FIG. 6.

This makes it possible to flexibly adjust the basic pressure loss simply and precisely via the corresponding angle position of the control valve 7. Orifices used to date for this basic pressure loss adjustment can be dispensed with, which reduces the procurement costs of the system.

The orifice plate flow meters 8 are not designed differently for different sizes of the drying bin 1 for a defined air quantity range.

In the described exemplary embodiments, the adjustable control valves 7 on the drying bins 1 are used to adjust the individual air quantity that is to flow though the respective drying bin 1. The orifice plate flow meters 8 of the drying bins 1 are used in the manner described to measure the actual individual air quantity. The actual individual air quantity can thus be measured with the optimum orifice plate flow meter 8, even by other flow measurement units.

The orifice plate flow meter 8 of the drying air generators 17 is used to measure the actual total air quantity. Here as well, another flow measurement unit can also be used instead of the orifice plate flow meter.

To adjust the total air quantity at the drying air generator 17 it is advantageous to use the fan 18 with the frequency converter 23, with the help of which the total air quantity can be easily and accurately adjusted via the speed of the fan 18.

Instead of the frequency converter 23, the bypass line 26 (FIG. 4) can also be used, which also makes it easy to change the total air quantity.

An exemplary explanation with numerical values is given with reference to FIG. 12. However, this is not intended to restrict the materials and numerical values given, nor the system described by way of example.

The exemplary system has the drying air generator 17, which is provided with the shared drying air duct 2′ and the shared return air duct 3′. The drying bins 1a to 1c are connected to the drying air duct 2′ and to the return air duct 3′ with their corresponding drying air ducts 2 and return air ducts 3, respectively. In each drying air duct 2 of each drying bin 1a to 1c, there is case a control valve 7 and a flow meter 8.

The drying air generator 17 has the fan 18 with the frequency converter 23. The frequency converter 23 is used in the manner described to adjust the speed of the fan.

The drying bin 1a contains ABS as material, the drying bin 1b PE and the drying bin 1c POM. It is also assumed that the drying bins 1a to 1c are filled to the maximum.

ABS has a maximum throughput D of 90 kg/h, a bulk density S of 0.9 kg/l and an assumed drying time of T of 3.5 h.

For PE situated in the drying bin 1b, the following figures are given: D=110 kg/h, S=0.6 kg/l and T=2.0 h.

The corresponding numerical values for the POM in the drying bin 1c are: D=40 kg/h, S=0.7 kg/l and T=2.5 h.

Using these numbers, the volume of the corresponding drying bin 1a to 1c can be calculated according to the formula

$$V = D \times T / S$$

For the values given above as an example, this thus results for the drying bin 1a in a required volume V of 350 l, for drying bin 1b a volume V of 367 l and for the drying bin 1c a volume V of 143 l.

Accordingly, 400-l bins are used for the drying bins 1a and 1b and a 150-l bin is used for the drying bin 1c.

The required individual air quantity for each drying bin 1a to 1c can be calculated according to the formula

Q=specific air quantity (m³/kg)×max. throughput (kg/h).

For the drying bin 1a, a specific air quantity of 1.3 m³/kg is assumed, for the drying bin 1b a specific air quantity of 2.0 m³/kg is assumed and for the drying bin 1c a specific air quantity von 1.2 m³/kg is assumed. Taking into account the specified throughput D of 90 kg/h, 110 kg/h and 40 kg/h, the following individual air quantities are required for the individual drying bins 1a to 1c:

$${Q}_{1 a} = 1.3 {m}^{3} \text{/kg} \times 90 \text{kg/h} = 117 {m}^{3} \text{/h} \\ {Q}_{1 b} = 2. {m}^{3} \text{/kg} \times 110 \text{kg/h} = 220 {m}^{3} \text{/h} \\ {Q}_{1 c} = 1.2 {m}^{3} \text{/kg} \times 40 \text{kg/h} = 48 {m}^{3} \text{/h}$$

The calculated individual air quantities Q form the setpoint individual air quantities of the respective drying bins 1a to 1c.

Adding up the setpoint individual air quantities Q gives the total air quantity Qₜₒₜ as setpoint total air quantity:

$${Q}_{tot =} {Q}_{1 a} + {Q}_{1 b} + {Q}_{1 c} = 117 {m}^{3} / h + 220 {m}^{3} / h + 48 {m}^{3} / h = 385 {m}^{3} / h$$

The drying air generator 17 must accordingly provide this setpoint total air quantity. In the example, the size selected for the drying air generator 17 is one that delivers a maximum of 400 m³/h.

At the start of the drying process, the drying bins 1a to 1c and the drying air generator 17 are switched on. All of the control valves 7 are at a predefined actuating angle based on the 100% air quantity control, or alternatively they are fully open. The drying air generator 17 firstly introduces the maximum air quantity as total air quantity into the system; in the example Qₜₒₜ=400 m³/h.

At certain points in time, the control units 12 are used to calculate the setpoint individual air quantities via the mentioned specific air quantities for each material and the material quantities in the drying bins 1a to 1c, which are detected by means of the options described. The corresponding values are supplied to the control unit 12 of the drying air generator 17 in defined time intervals (arrow I).

The control unit 12 of the drying air generator 17 calculates the setpoint total air quantity (II) from the supplied data (I) after a specified waiting time.

The drying air generator 17 calibrates the actual total air quantity with the calculated setpoint total air quantity (II) by means of the orifice plate flow meter 8. The drying air generator 17 carries out the regulation until the actual total air quantity and the setpoint total air quantity are the same, taking into account permissible tolerances.

In the example, the total air quantity of the drying air generator 17 is adapted by regulating the speed of the fan 18 using the frequency converter 23 and calibrating the flow measurement using the orifice plate flow meter 8.

When the actual total air quantity is the same as the setpoint total air quantity, the control unit 12 of the drying air generator 17 sends a signal (III) to the control unit 12 of the drying bin 1a, to inform this control unit that the required setpoint total air quantity is adjusted.

As soon as the control unit 12 of the drying bin 1a has received the corresponding signal from the control unit 12 of the drying air generator 17, the control unit 12 of the drying bin 1a in conjunction with the orifice plate flow meter 8 measures the actual individual air quantity of the drying bin 1a. If the measured actual individual air quantity corresponds to the calculated setpoint individual air quantity, the control unit 12 of the drying bin 1a sends a corresponding signal IV to the control unit 12 of the subsequent drying bin 1b.

If the actual individual air quantity does not correspond to the setpoint individual air quantity, taking into account permissible tolerances, the control unit 12 continues to perform the regulation until the two values match. The individual air quantity is adapted using the control valve 7 and the flow measurement is calibrated using the orifice plate flow meter 8 and a formula saved for the orifice plate flow meter.

As soon as the setpoint and the individual air quantity match, sends the control unit 12 of the drying bin 1a sends the corresponding signal to the control unit 12 of the subsequent drying bin. The drying bin 1b is now adjusted in the same way as described for the drying bin 1a and sends a signal V to the drying bin 1c.

In this way, all of the drying bins in the system are adjusted one after the other.

As soon as the last drying bin in the system, in the example drying bin 1c, has been adjusted in the same way as described for drying bins 1a and 1b, the control units 12 of the drying bin 1c sends a corresponding signal VI to the control unit 12 of the drying air generator 17. The control unit 12 of the latter now checks again whether the actual total air quantity still corresponds to the setpoint total air quantity. A readjustment is likely because of because of the pressure and volume flow change due to the respective position of the control valve 7. The control unit 12 of the drying air generator 17 then performs the regulation until the actual total air value-corresponds to the setpoint total air value, taking into account permissible tolerances.

The actual air quantities of the drying air generator 17 and the drying bins 1a to 1c are iteratively approximated to the setpoint air quantities until all values, taking into account a permissible tolerance range, are equal in each case.

A particular advantage of the method is that with a changed material throughput, the heat input can be changed by adjusting the drying air quantity in combination with adapting the heating performance. When the material throughput is changed, the system is adjusted in the same way as was described for the first drying process.

When a material in a drying bin is exchanged, the air quantity is adapted by selecting the material in the drying bin in a database and continuously recalculating the required individual air quantity.

In this way, automatic air dimensioning is achieved, wherein the drying air optimally distributed to the drying bins and in line with the requirements of the respective materials in the drying bins. The heat input can thus be optimally matched to the material and the drying bin. The material to be dried in the drying bin receives precisely that quantity of air that is required for the drying process. The method thus operates in a very energy-saving manner. In addition, the material is optimally protected.

The total air quantity provided by the drying air generator 17 is optimally matched to auf the individual air quantities required by the drying bins, meaning that the drying air generator 17 only delivers as much air as the drying bins need. This results in a big energy saving and good material protection.

The system is advantageously designed such that the described regulation takes place automatically. The setpoint air quantities are adjusted fully automatically, meaning that a manual adjustment by calibration with a rough air quantity display can be dispensed with.

What is claimed is:

1. A method for drying a plastic material in the form of granules, powder, and the like, comprising:
generating drying air using a drying air generator (17);
conducting the drying air through the plastic material situated in a drying bin (1);
causing the drying air to absorb moisture in the plastic material and exit the drying bin (1) as return air;
detecting an actual air quantity of the drying air supplied to the drying bin (1) by a flow measurement and regulating the actual air quantity to a setpoint air quantity; and
regulating an actual total air quantity of the drying air exiting from the drying air generator (17) to a setpoint total air quantity.

2. The method according to claim 1,
wherein the flow measurement is performed by an orifice plate flow meter (8) in conjunction with a differential pressure-air characteristic curve.

3. The method according to claim 2, further comprising
measuring a differential pressure at the orifice plate flow meter (8).

4. The method according to claim 1, further comprising
adjusting a back-pressure of the drying bin (1).

5. The method according to claim 2, further comprising
using a differential pressure, a temperature of the drying air supplied to the drying bin (1), a static air pressure, a gas constant for the drying air, and a formula saved for a geometry of the orifice plate flow meter (8) to determine the actual air quantity.

6. The method according to claim 2, further comprising
using a differential pressure at the orifice plate flow meter (8), a formula saved for a geometry of the orifice plate flow meter (8), a temperature of the drying air leaving the drying air generator (17), a static air pressure, and a gas constant for the drying air to determine the actual total air quantity.

7. The method according to claim 6,
wherein the static air pressure is measured in a pipe (2, 2′) of the drying bin (1) or of the drying air generator (17) or in a surrounding area.

8. The method according to claim 1, further comprising
adjusting a speed of a fan (18) to change the actual total air quantity.

9. The method according to claim 1, further comprising
discharging air from a pipe (2′) of the drying air generator (17) by at least one bypass line (26) to change the actual total air quantity.

10. The method according to claim 1,
wherein the drying bin (1) is one of at least two drying bins (1) connected to the drying air generator (17), and
wherein the method includes
adjusting the actual total air quantity of the drying air generator (17), and
subsequently adjusting the actual air quantity of the at least two drying bins (1) one after another.

11. The method according to claim 10,
wherein the at least two drying bins (1) send their actual air quantity values to a control unit (12) of the drying air generator (17), and
wherein the control unit (12) calculates the actual total air quantity from the actual air quantity, compares it to a setpoint total air quantity and regulates it until the actual total air quantity corresponds to the setpoint total air quantity, taking into account a permissible tolerance.

12. The method according to claim 10, further comprising
adjusting the actual total air quantity of the drying air generator (17), and
subsequently enabling the at least two drying bins (1) by an enable signal to adjust the actual air quantities.

13. A system for drying a plastic material, comprising:
a drying air generator (17) for generating drying air;
at least two drying bins (1) connected to the drying air generator (17) by a drying air duct (2, 2′) and a return air duct (3, 3′);
an orifice plate flow meter (8) located in the drying air duct (2); and
a motor-adjustable control valve (7) connected upstream of the orifice plate flow meter (8) in the drying air duct (2),
wherein the system is configured
to conduct the drying air through the plastic material situated in the at least two drying bins (1),
to cause the drying air to absorb moisture in the plastic material and exit the at least two drying bins (1) as return air,
to detect an actual air quantity of the drying air supplied to the at least two drying bins (1) by the orifice plate flow meter (8) and to regulate the actual air quantity to a setpoint air quantity, and
to regulate an actual total air quantity of the drying air exiting from the drying air generator (17) to a setpoint total air quantity.

14. The system according to claim 13,
wherein the orifice plate flow meter (8) is coupled to a differential pressure transducer (9), and
wherein the differential pressure transducer (9) is signal-connected to a control unit (12).

15. The system according to claim 14,
wherein a motor (16) of the motor-adjustable control valve (7) is connected to the control unit (12).

16. The system according to claim 14,
wherein a pressure gauge (15) and a temperature sensor (10) detect a pressure and a temperature of the drying air in the drying air duct (2), and
wherein the pressure gauge (15) and the temperature sensor (10) are connected to the control unit (12).

17. The system according to claim 13,
wherein the orifice plate flow meter (8) is connected downstream of a speed-adjustable fan (18).

18. The system according to claim 17,
wherein a speed of the speed-adjustable fan (18) can be adjusted by a frequency converter (23).

19. The system according to claim 17,
wherein the orifice plate flow meter (8) of the drying air generator (17) is coupled to a differential pressure transducer (9), and
wherein the differential pressure transducer (9) is signal-connected to a control unit (12).

20. The system according to claim 14,
wherein the drying air duct (2′) and the return air duct (3′) of the drying air generator (17) are connected by a bypass line (26) in which there is a motor-driven control valve (7), and
wherein a motor (16) of the motor-driven control valve (7) is connected to the control unit (12).
